(19) United States
(12) Patent Application Publication
(10) Pub. No.: US 2024/0220793 A1
(43) Pub. Date: Jul. 4, 2024

(54) ONTOLOGY-BASED FRAMEWORK FOR INTERPRETABLE FEATURE ENGINEERING

(71) Applicant: SAP SE, Walldorf (DE)

(72) Inventors: Mohamed BOUADI, La Garenne-Colombes (FR); Arta ALAVI, Andresy (FR); Salima BENBERNOU, Colombes (FR); Mourad OUZIRI, Gennevilliers (FR)

(21) Appl. No.: 18/178,768

(22) Filed: Mar. 6, 2023

Related U.S. Application Data
(60) Provisional application No. 63/436,253, filed on Dec. 30, 2022.

(51) Int. Cl. G06N 3/08

(52) U.S. Cl. CPC G06N 3/08

(57) ABSTRACT

Systems and methods include generation of a first plurality of features using a learning network, determination of an interpretability of each of the first plurality of features based on a domain ontology and on symbolic rules associated with entities of the domain ontology, determination of a first set of the first plurality of features which were determined as interpretable, determination of a performance of a model trained using the first set of the plurality of features, determine a reward based on the performance and the interpretability, and generation of a second plurality of features using the learning network based on the reward.

### CROSS-REFERENCE TO RELATED APPLICATIONS

The present application claims priority to U.S. Provisional Patent Application Ser. No. 63/436,253, filed Dec. 30, 2022, the contents of which are incorporated herein by reference for all purposes.

### BACKGROUND

Organizations have long employed computing systems to manage and store operational data. The volume of such data has grown exponentially over time, resulting in continuous development of new and more-efficient systems for handling such data. Systems to facilitate understanding and analysis of large data sets have similarly evolved.

Over the past decade, organizations have increasingly used modeling applications to predict future events based on stored data. These applications have been used to solve difficult problems and uncover new opportunities across a variety of domains. A modeling application typically provides tools for defining and training a machine learning (ML) algorithm which infers a desired output based on specified known inputs.

Unfortunately, defining and training an ML algorithm using existing tools is quite difficult for non-experts in the field. Generally, it is required to gather suitable training data, define model inputs (i.e., feature selection) from the training data, select a model architecture, train the model, and deploy the model. Each of the foregoing steps is replete with corresponding decisions and uncertainties.

For example, the goal of feature selection is to select features which result in an efficient and accurate ML algorithm. The performance of a particular set of features may be validated by prior knowledge or by tests using synthetic and/or actual data sets. However, selecting an optimal set of features presents an intractable computational problem.

In particular, the number of possible features that can be constructed is unlimited. Moreover, transformations can be composed and applied recursively to the features generated by previous transformations. In order to confirm whether a newly-composed feature is relevant, a new model including the feature is trained and evaluated. This validation is costly and impractical to perform for each newly-constructed feature.

In view of the foregoing, feature selection (i.e., feature engineering) is primarily performed manually by a data scientist. The data scientist uses intuition, a background in data mining and statistics, and domain knowledge to extract useful features from stored data, and to refine the features through trial and error by training corresponding models and observing their relative performance.

Existing feature selection systems attempt to automate portions of the feature engineering process using, for example, a search framework or a correlation model. Since an algorithm trained based on the selected features is used to make important decisions, the selected features are preferably not only statistically important but also interpretable by domain experts to enhance trust associated with the output of the algorithm. Improved automation of the feature engineering process to efficiently generate effective and interpretable features is desired.

### BRIEF DESCRIPTION OF THE DRAWINGS

FIG. 1 is a block diagram of an architecture to generate interpretable and statistically important features according to some embodiments.

FIG. 2 is a flow diagram of a process to generate interpretable and statistically important features according to some embodiments.

FIG. 3 illustrates logical entities of an ontology according to some embodiments.

FIG. 4 illustrates examples of units of measurement logical entities of an ontology according to some embodiments.

FIG. 5 is a detailed block diagram of an architecture to generate interpretable and statistically important features according to some embodiments.

FIG. 6 is a diagram of a portion of a features taxonomy according to some embodiments.

FIG. 7 illustrates a portion of a flattened taxonomy mapped to a feature vector according to some embodiments.

FIG. 8 is a block diagram of an architecture to generate a fixed-size composite feature vector representing a plurality of features according to some embodiments.

FIG. 9 is a diagram of a portion of a domain ontology according to some embodiments.

FIG. 10 is a block diagram of an architecture to train a model to output a target based on a set of features and training data.

FIG. 11 is a block diagram of an architecture to determine model performance based on a set of features and test data.

FIG. 12 is an outward view of an interface presenting selected input features of a trained model according to some embodiments.

FIG. 13 illustrates a system to provide trained models to applications according to some embodiments.

FIG. 14 is a block diagram of a hardware system for providing trained models according to some embodiments.

### DETAILED DESCRIPTION

The following description is provided to enable any person in the art to make and use the described embodiments. Various modifications, however, will be readily-apparent to those in the art.

Feature engineering is often conducted by domain experts who are not necessarily skilled in statistics or data science. In contrast, if feature engineering is conducted by those skilled in machine learning concepts but not in the relevant domain, it must be ensured that the constructed features are interpretable and related to the concepts familiar to domain experts. Some embodiments provide a scalable solution to automate feature engineering that is more likely to obtain features with statistical significance and which also remain interpretable by domain experts.

Some embodiments relate to automating portions of feature engineering using an autonomous agent that generates features iteratively and is trained based on the statistical importance and the interpretability of its generated features. The statistical performance of a set of features may be determined based on a performance of a machine learning model which is trained based on the set of features, and the interpretability may be determined based on rules (i.e., assertions) of a domain ontology. The agent may comprise a deep reinforcement learning network which determines, based on intermediate rewards, a set of features which maximizes a long-term (i.e., cumulative) reward.

Generation of interpretable features includes evaluation of the degree of interpretability of features during the feature generation process. The degree of interpretability of features is evaluated with respect to the semantics of the entities and concepts of the domain of interest. Interpretability refers to the ability of domain experts to make sense of a generated feature, i.e., to map the generated feature into the domain of interest in order to better understand the training data of a learning model. Some embodiments consider the interpretability of a feature as a binary measure (i.e., True or False).

Explainability of a feature may consist of providing the minimal set of elements of the domain ontology (i.e., axioms and assertions) that led to the inferred result. An explanation of an interpretable feature fᵢ from the knowledge base KB, denoted by KB [symbol] fᵢ, is given by the trace KB′⊆KB, such that KB′ [symbol] fᵢ and there is no other knowledge set KB″⊆KB′ so that KB″ [symbol] fᵢ.

In some embodiments, the deep reinforcement learning network comprises a fixed-size input layer for receiving a fixed-size composite feature vector. The fixed-size composite feature vector may represent any number of input features, where each feature is also represented by a same-sized feature vector. A feature vector representing a given feature may be generated based on logical entities of a features taxonomy derived from the above-mentioned domain ontology.

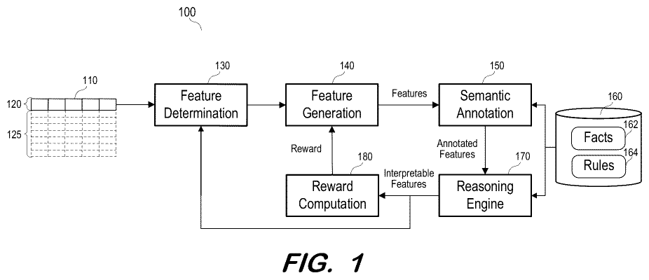

FIG. 1 is a block diagram of architecture 100 to generate interpretable and statistically important features according to some embodiments. All components illustrated herein may be implemented using any suitable combination of computing hardware and/or software that is or becomes known. In some embodiments, two or more components are implemented by a single computing device or may be co-located. One or more components may be implemented as a cloud service (e.g., Software-as-a-Service, Platform-as-a-Service). A cloud-based implementation of any components may apportion computing resources elastically according to demand, need, price, and/or any other metric.

Generation of features according to some embodiments may address a predictive modeling problem consisting of a dataset, D, with raw features, F={f₁, . . . , fₙ}, and a target vector, y, a set of transformations, T={t₁, . . . , tₖ}, an applicable learning algorithm L and a measure of performance m (such as F1-score). P^{m}(F, y) is defined as cross-validation performance using measure m for the model constructed on given data with algorithm L. Algorithm L may comprise a linear regression algorithm, a classification algorithm, or any other suitable algorithm which might or might not be implemented using a neural network. Embodiments may therefore be used to determine a set of features, F*=F₁∪F₂, where F₁⊆F (original) and F₂⊆F_{T} (derived), to maximize the modeling accuracy for a given algorithm L and measure m and which reflect concepts known by domain experts, i.e.,

$${F}^{*} = arg {max}_{F 2} {P}_{L}^{m} ( {F}_{1} ⋃ {F}_{2} , y ) . \\ s . t . \\ max {Σ}_{f ∈ F} \cdot I ( f ) \\ I ( f ) ∈ \{ 0 , 1 \} , ∀ f ∈ {F}^{*}$$

where I is the interpretability function that maps an abstract concept (a new feature f∈F*) into a domain that an expert can interpret.

Database table 110 may comprise any set of data values that is or becomes known. Table 110 includes five columns of data 125, where each column includes data values corresponding to one of five features 120. In some embodiments, table 110 includes columns in addition to those associated with features 120. According to some embodiments, features 120 are referred to as “raw” features because the data values associated therewith are identical to the data values of the corresponding columns of table 110. As will be described below, other features may be generated based on one or more raw features. The data values associated with such other features are not natively stored in table 110 but are instead generated from the native data values.

According to the present example, features 120 are input to feature determination component 130. For example, text names associated with each feature 120 are input to feature determination component 130. The text names may be identical to the column names of the columns of table 110 associated with each feature 120. Feature determination component 130 may simply pass the text names to feature generation component 140, may operate to generate a single feature vector based on each of the input features as described below, or may provide any other data indicative of features 120 to feature generation component 140.

Feature generation component 140 operates to generate features based on the features received from component 130. Feature generation component 140 may comprise any suitable system for generating one or more features based on a received feature vector and a reward computed based on prior-generated features. Examples of feature generation component 140 according to some embodiments are provided below.

Semantic annotation component 150 receives the features from feature generation component 140 and annotates the features based on logical entities specified in facts 162 of domain ontology 160. Domain ontology 160 may be considered a knowledge base defining a hierarchy of n logical entities, as well as assertions, or rules, 164. According to some embodiments, semantic annotation component 150 may map each of the received features to one or more of the logical entities of facts 162. For example, it is assumed that a feature received by semantic annotation component 150 is the sum of a product weight feature and a packaging weight feature, each of which is specified in raw features 120. Semantic annotation component 150 may map the product weight feature to an “item weight” entity and to a “kilogram” unit of measurement entity specified in facts 162, and may map the packaging weight feature to a “package weight” entity and to a “pounds” unit of measurement entity specified in facts 162.

The thusly-annotated features are received by reasoning engine 170. Reasoning engine 170 may use assertions or rules 164 to determine whether or not each of the annotated features is “interpretable”. In this regard, rules 164 may comprise Description Logics (DL) which defines, based on annotations referring to facts 162, scenarios in which a feature is considered interpretable and scenarios in which a feature is considered uninterpretable. DL represents a formal framework having a knowledge expression language to express the semantics (e.g., facts) of a domain of interest and reasoning algorithms (e.g., rules) that may be executed by reasoning engine 170 to generate logical inferences from the expressed knowledge.

For example, a rule 164 may specify that two features associated with different units of measurement cannot be added. A feature consisting of the sum of two of such features should therefore be considered uninterpretable. Reasoning engine 170 may evaluate the rule against the above-described feature comprising the sum of a product weight feature and a packaging weight feature and determine that the feature is uninterpretable (i.e., because the product weight feature and the packaging weight feature are associated with different units of measurement per their annotations).

Reasoning engine 170 passes features identified as interpretable to reward computation component 180. In some embodiments, reasoning engine 170 passes to reward computation component 180 all features which have not been identified as uninterpretable (i.e., features identified as interpretable and features which reasoning engine 170 could not identify as interpretable or non-interpretable).

Reward computation component 180 determines a reward based on the interpretable features. In one simple example, the reward is based on the ratio of interpretable features to uninterpretable features generated by feature generation component 140. Any other metrics may be used to determine the reward, including metric which consider features which could not be identified as either interpretable or uninterpretable.

Reward computation component 180 also determines the reward based on the performance of a model which is trained using the interpretable features. Accordingly, the reward may be calculated based on the interpretable features and their statistical importance to give the best tradeoff between interpretability and accuracy. The model may comprise the above-mentioned algorithm L and the performance of the algorithm may be determined by evaluating measure m after training the algorithm using the interpretable features (and corresponding training data) as is known in the art.

According to some embodiments, the interpretable features (and, in some embodiments, features which were not identified as interpretable or uninterpretable) are fed back to feature determination component 130. Feature determination component 130 may determine a feature vector representing these features and, in some embodiments, also representing features 120 and any other previously-determined interpretable features, and input the feature vector to feature generation component 140.

The components of architecture 100 may continue to operate as described above until convergence of the iterations or until a time limit or other threshold is reached such as but not limited to an overall number of interpretable features generated by architecture 100, a performance of a trained algorithm using these generated interpretable features, a number of iterations performed by architecture 100, and any other suitable metric.

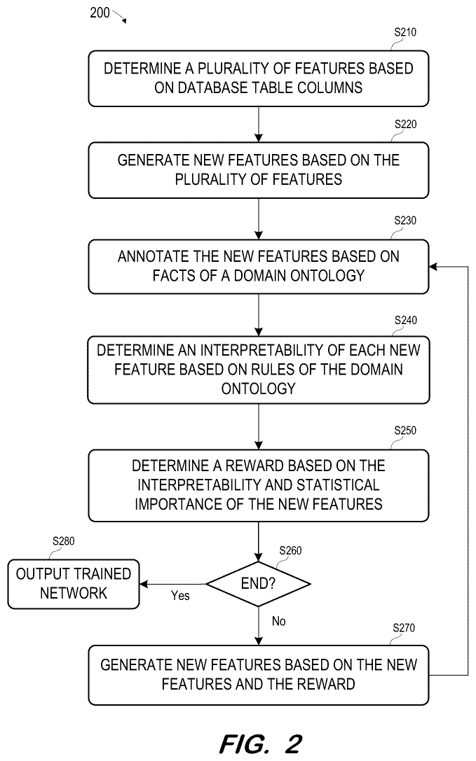

FIG. 2 comprises a flow diagram of process 200 to generate composite feature vectors representing a plurality of features according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any one or more processing units, including but not limited to a microprocessor, a microprocessor core, and a microprocessor thread. Embodiments are not limited to the examples described below.

Initially, a plurality of features are determined at S210 based on columns of one or more database tables. The plurality of features may simply comprise a plurality of columns, in which case the features are considered “raw” features. It is assumed that each column includes rows of data values conforming to metadata defining the column (e.g., column name, data type).

New features are generated based on the plurality of features at S220. According to some embodiments, a trainable network outputs a transformation, or operator, at S220 based on the input features. The transformation is applied to the input features to generate new features at S220. The new features are annotated based on facts of a domain ontology at S230. As described above, each of the new features may be mapped to one or more logical entities of a domain ontology to connect the features to their meaning that is encoded in the ontology.

The domain ontology may be constructed using the Attributive Language (AL) of DL, in which information regarding concepts and features is stored in an RDF representation. DL refers to the class of logics that represent terminological knowledge. This class of logics is suited to represent domain rules since it is concerned with the properties of domain concepts and their interpretation. Moreover, DL is able to formalize the semantics of a domain and to perform reasoning such as subsumption reasoning using subsumption reasoning algorithms, such as structural algorithms and Tableaux algorithms (i.e., constraint propagation). Many DL languages exist, differing in their expressiveness and the complexity of the underlying reasoning algorithms.

The ontology may be organized in four super-classes and a set of rules (i.e., Assertions). The ontology includes logical components that formalize information in terms of classes, binary relations and individuals (i.e., facts) which may thus be considered as a directed knowledge graph where entities are organized into class-subclass hierarchies based on Based on isA (aka subclass), hasUnit, hasInput, hasOutput between classes and memberOf between an individual and a class.

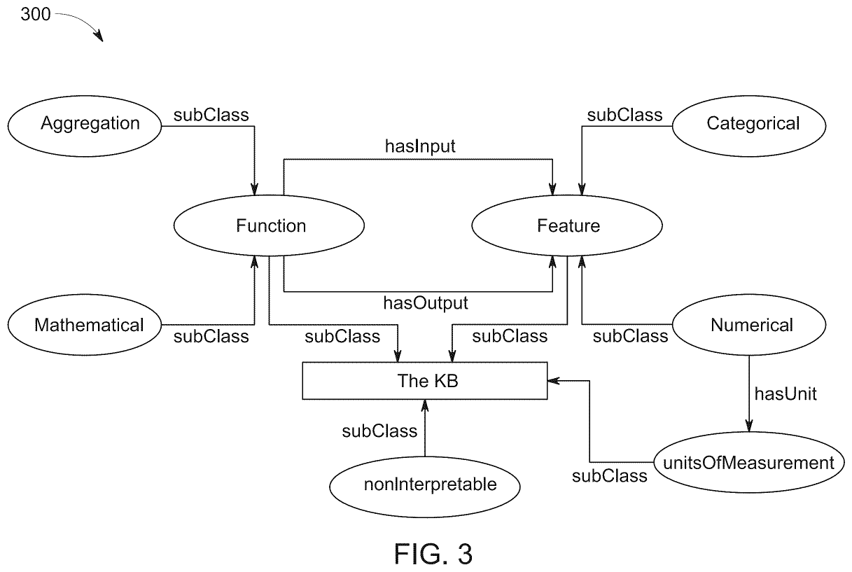

FIG. 3 shows four super-classes 300 of an ontology according to some embodiments. The Feature super-class may include numerical and/or categorical features, the Function super-class may include arithmetic or aggregation functions, and the unitsofMeasurement super-class may include any units of measurement. Each super-class may include a hierarchy of sub-classes.

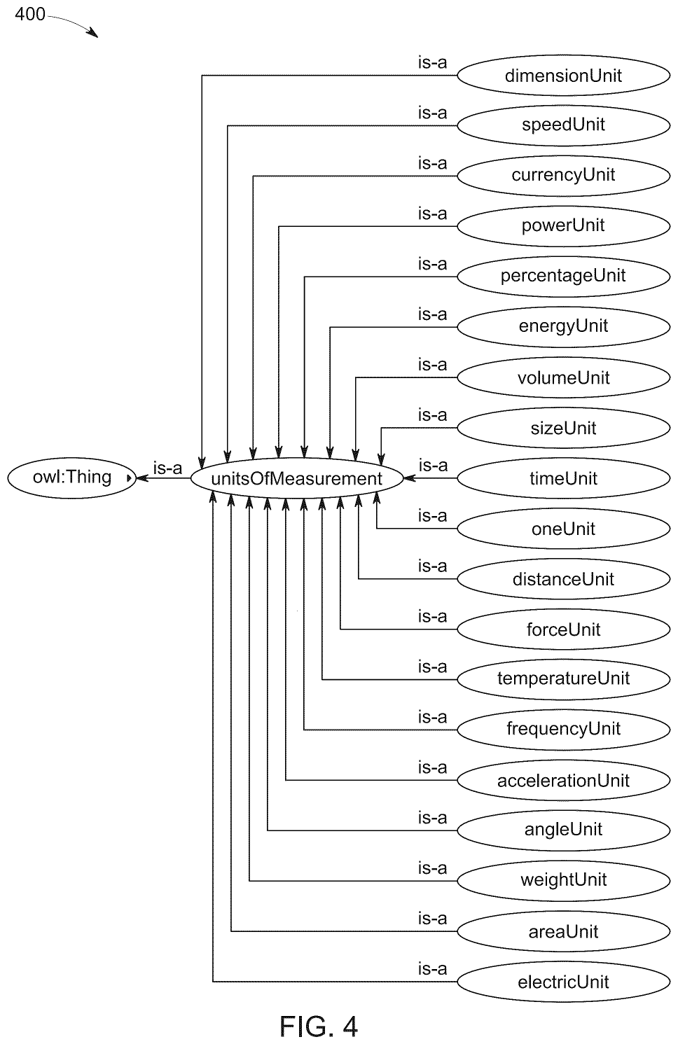

The class Feature provides clear semantics of a large number of features that can be found in specific domain datasets. It includes categorical features (e.g., Gender, Location, Name, Address), and numerical features (e.g., Id, Date, Price, Income, Age, Amount), where Date can include transaction-date, order-date, purchase-date, etc. The class Function presents the vocabulary and the rules to semantically declare and describe the transformation functions (i.e., operators) described herein. unitsOfMeasurement provides sub-classes and instances to define measures and units. It includes, for instance, the International System of Units (SI) such as meter and kilogram, units from other systems of units such as the mile, and more specific quantities for a large number of application areas such as Geometry and Mechanics. FIG. 4 depicts sub-classes 400 of the unitsofMeasurement super-class.

The class nonInterpretable contains concepts and individuals that are considered as non-interpretable for domain experts. The class includes a set of rules that identify whether a generated feature may be non-interpretable (e.g., summing two features that have different units of measurement results in a non-interpretable feature, or periodic inventory totals are not summable).

An interpretability of each new feature is determined at S240 based on rules of the domain ontology. A reasoning algorithm may be used at S240 to determine whether a new generated feature is interpretable or not according to the domain knowledge as represented by a domain ontology. The determination may be modeled as a logical satisfiability problem (i.e., a SAT problem) for which the answer is either one (i.e., interpretable) or zero (i.e., non-interpretable).

As described above, some embodiments utilize (AL) DL, which allows efficient knowledge capture. Any reasoning algorithm may be employed at S240, including but not limited to HermiT, which is a reasoner for knowledge bases written using the Web Ontology Language (OWL). OWL is designed to represent rich and complex knowledge about entities and the relations between them. The sub-language OWL-DL is based on DL language and may in some implementations offer a suitable trade-off between high expressiveness and computational completeness (i.e., all entailments are guaranteed to be computed) and decidability (i.e., all computations will finish in finite time).

To decide if a new feature f∈F with unit of measurement u is interpretable at S240, the algorithm checks for inconsistencies using symbolic reasoning, namely subsumption (KB [symbol] f⊆C ?) where C is a class of the ontology and instance checking reasoning (KB [symbol] D(u)?), where D is a sub-class of unitsOfMeasurement (DE unitsOfMeasurment). This check reduces the interpretability problem to an SAT problem. First, each generated feature f∈F is considered as a new class and a subsumption reasoning is performed by checking for unsatisfiability. If f is unsatisfiable (i.e., KB∪{f}≡⊥) then f is considered as uninterpretable with respect to the domain ontology and will be discarded. If not enough information about the new feature is available, the algorithm will exploit the knowledge facet of units and quantities that are stored as instances of the super-class unitsOfMeasurement. The instance checking is also reduced to an SAT problem, i.e., if KB U {D(u)}≡1, where u is the unit of f and D ⊏unitsOf Measurement, then f is considered as non-interpretable.

A reward is determined at S250 based on the interpretable features (or not non-interpretable) determined at S240 and on the statistical importance of these features. The statistical importance may be determined based on the performance of a model which is trained using the features. The model may comprise the above-mentioned algorithm L and the performance of the algorithm may be determined by evaluating measure m after training the algorithm using the interpretable features (and corresponding training data) as is known in the art.

At S260 it is determined whether to end process 200. The determination may be based on whether the iterations of process 200 have converged, a time limit has been reached, or another threshold has been reached, for example. If not, new features are generated based on the reward and the interpretable features (or the interpretable features and the features which have not been determined as non-interpretable) at S270. According to some embodiments, the trainable network mentioned above receives the reward and a representation of the interpretable features and determines new features based thereon. Flow then returns to S230 to annotate the newly-generated features and continues as described above.

Flow proceeds to S280 once it is determined at S260 to end process 200. At S280, the network is considered trained and may be output for future use as is known in the art. In particular, the trained network may be used to generate statistically-important and interpretable features based on a set of input features. The network may be used iteratively to generate additional statistically-important and interpretable features based on its output features and the original set of input features. The network may be output in the form of node weights, an executable algorithm, a set of linear equations, or any other suitable implementation of a trained network which may be used for inference.

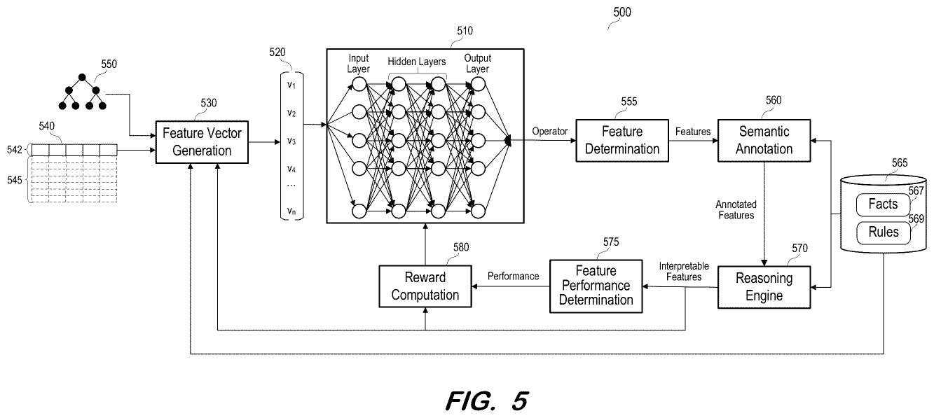

FIG. 5 is a block diagram of architecture 500 to train a model to determine interpretable features according to some embodiments. As noted above, architecture 500 may be used to determine a set of features, F*=F₁∪F₂, where F₁⊆F (original) and F₂⊆F_{T} (derived), to maximize the modeling accuracy for a given algorithm L and measure m and which reflect concepts known by domain experts, i.e.,

$${F}^{*} = arg {max}_{F 2} {P}_{L}^{m} ( {F}_{1} ⋃ {F}_{2} , y ) . \\ s . t . \\ max {Σ}_{f ∈ F} \cdot I ( f ) \\ I ( f ) ∈ \{ 0 , 1 \} , ∀ f ∈ {F}^{*}$$

where I is the interpretability function that maps an abstract concept (a new feature f∈F*) into a domain that an expert can interpret.

Some embodiments employ a deep Q-network method to effectively automate the process of trial and error to determine a set of input features. Generally, a deep reinforcement learning agent may optimize the exploration policy on historical data. For example, at each training step, deep reinforcement learning agent 510 receives a composite feature vector 520 representing a particular set of input features, uses a multi-layer neural network to calculate an intermediate reward score for each possible operator that can be applied on the feature set, and selects an operator that maximizes the long term reward. An operator may comprise a transformation operator or function which may be applied to one or more features to result in one or more other features.

Architecture 500 includes feature vector generation component 530 for generating instances of fixed-size composite feature vector 520 representing a respective plurality of features. In the present example, database table 540 may comprise any set of data values that is or becomes known. Table 540 includes five columns of data 545, where each column includes data values corresponding to one of five features 542. In some embodiments, table 540 includes columns in addition to those associated with features 542.

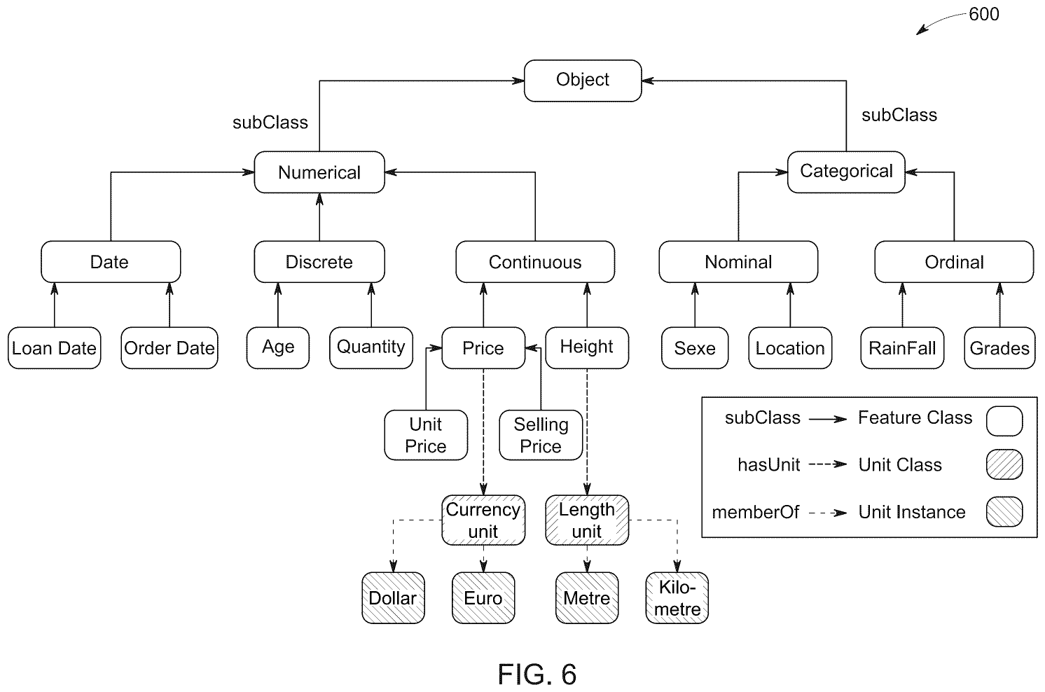

According to the present example, features 542 are input to feature vector generation component 530. Feature vector generation component 530 uses features taxonomy 550 to generate a feature vector corresponding to each feature 542. Features taxonomy 550 defines a hierarchy of n logical entities. FIG. 6 illustrates portion 600 of a features taxonomy according to some embodiments. Portion 600 includes logical entities consisting of classes, subclasses, unit classes and unit instances, but embodiments are not limited thereto.

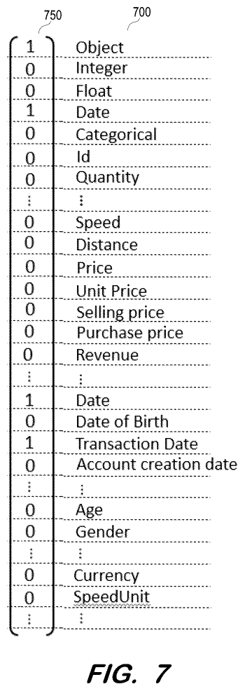

According to some embodiments, feature vector generation component 530 identifies, for each feature 542, those logical entities of taxonomy 550 of which the feature is a member and assigns a value of 1 to the entries of a feature vector which correspond to the identified logical entities. The feature vector for a given feature 542 is therefore a flattened version of size 1×n of the hierarchy of n logical entities. FIG. 7 shows flattened representation 700, in which each logical entity of a taxonomy is listed along with any sibling entities immediately below its parent logical entity. Embodiments are not limited thereto.

Feature vector 750 corresponds to one feature and includes an entry for each logical entity of flattened ontology 700 which corresponds to the feature. A feature may be named identically to a logical entity of taxonomy 550, in which case the entries of the feature vector associated with the logical entity and with all parent logical entities are set to 1. Feature vector generation component 530 may utilize direct and/or fuzzy mappings from text names of features to logical entities in order to generate feature vectors in which the appropriate entries are set to 1 or 0. According to some embodiments, a user may assist the generation of feature vectors for one or more features. For example, a user may determine that a feature is a member of a logical entity of taxonomy 550 and may issue an instruction to feature vector generation component 530 to set the entry of the feature's feature vector which corresponds to the logical entity to 1.

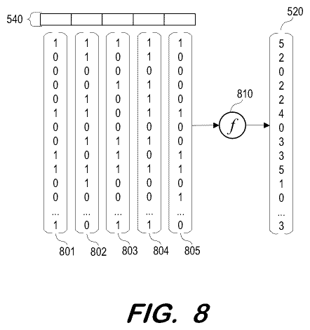

FIG. 8 illustrates feature vectors 801-805 output by feature vector generation component 530. Each of feature vectors 801-805 is based on a respective one of input features 540. As described above, each respective entry (i.e., the first, second, third, etc. entries) of each of feature vectors 801-805 corresponds to a same logical entity of ontology 550 and each of feature vectors 801-805 is therefore of the same size.

Function 810 is applied to feature vectors 801-805 to generate composite feature vector 520 which is input to agent 510. According to the illustrated example, function 810 is a summing function which sums respective entries of feature vectors 801-805. For example, the first entry of vector 520 is equal to the sum of the first entries of feature vectors 801-805, the second entry of vector 520 is equal to the sum of the second entries of feature vectors 801-805, etc. Embodiments are not limited to a summing function.

Advantageously, composite feature vector 520 represents each of features 540 in a semantically-relevant manner. In particular, composite feature vector 520 is generated based on the semantics of each of features 540, as defined by taxonomy 550. Feature generation systems may therefore utilize vector 520 as a proxy for features 540. Moreover, as in the present example of agent 510, such feature generation systems may include a fixed-size input layer corresponding to the fixed size of input composite feature vector 520.

As mentioned above, deep reinforcement learning network agent 510 determines an operator based on the received input composite feature vector 520. Agent 510 may model a Markovian Decision Process (MDP) according to some embodiments. MDP provides a mathematical framework for modeling decision making which comprises a finite or infinite set of states, S={sᵢ}; a finite set of actions, A={aᵢ}; a state transition function, T (s, a, s′), specifying the next state s given the current state s and action a; a reward function R(s, a, s′) specifying the reward given to the reinforcement learning agent for choosing an action a in a state s and transitioning to a new state s′; and a policy π: S→A defining a mapping from states to actions.

A state sᵢ in the present example corresponds to a composite feature vector ø(X) provided to the deep reinforcement learning network and the set of actions A corresponds to the set of operators represented in the output layer of the deep reinforcement learning network (i.e., arithmetic and aggregation functions such as, for example, Log, Square, Square Root, Product, ZScore, Aggregation (using Min, Max, Mean, Count, Std, mode, Sum), Temporal window aggregate, k-term frequency, Addition, Difference, Division, multiplication, Sin, Cos, Tan H). The deep reinforcement learning network may attempt to determine an action (i.e., operator) which maximizes an estimate of a long-term cumulative reward, defined as:

$${Q}^{*} ( s , a ) = {max}_{π} E [ {r}_{t} + γ {r}_{t + 1} + {γ}^{2} {r}_{t + 2} + … \vert {s}_{t} = s , {a}_{t} = a , π ] ,$$

where function Q* represents the maximum sum of rewards r, discounted by factor y at each time step. The Q-function may be induced by the deep reinforcement learning network and may be parameterized as Q(s, a; θᵢ), where θᵢ are the parameters (i.e., weights) of the network at training iteration i.

The training process described below requires a dataset of experiences Dₜ=e₁, . . . eₜ, where every experience is described as a tuple eₜ=(sₜ, aₜ, rₜ, sₜ₊₁). The Q-function can be induced by applying Q-learning updates over mini-batches of experience MB={(s, a, r, s′)˜U(D)} drawn uniformly from dataset D. A Q-learning update at iteration i may be defined as the loss function:

$$> {L}_{i} ( {θ}_{i} ) = {E}_{MB} [ {( r + γ {max}_{a ′} Q ( {s}^{′} , {a}^{′} ; {\overline{θ}}_{i} ) - Q ( s , a ; {θ}_{i} ) )}^{2} ] ,$$

where θᵢ are the parameters of the neural network at iteration i, and θ̅ᵢ are the target parameters of the neural net at iteration i. The latter parameters are updated every C steps. This process may be implemented using the learning algorithm Deep Q-Learning with Experience Replay.

After calculating the Q-values, network 510 may apply an epsilon greedy algorithm to determine either the operator associated with a maximum reward or a random operator based on a certain input probability. The algorithm may comprise a decay epsilon-greedy algorithm which consists of selecting the operator with the maximum expected return with a probability of 1-∈ and selecting a random operator with a probability of ∈ over time, with the value of ∈ decaying over time. Accordingly, at the beginning of training, network 510 learns by exploring its environment. After a period of learning, ∈ is decreased to allow the network 510 to exploit its knowledge.

Feature determination component 555 uses the determined operator to generate a new set of features. The new set of features (e.g., a, b, c, a², b², c²) may include all of the features of the prior state (e.g., a, b, c) and new features (e.g., a², b², c²) transformed from the prior state using the determined operator (e.g., Square).

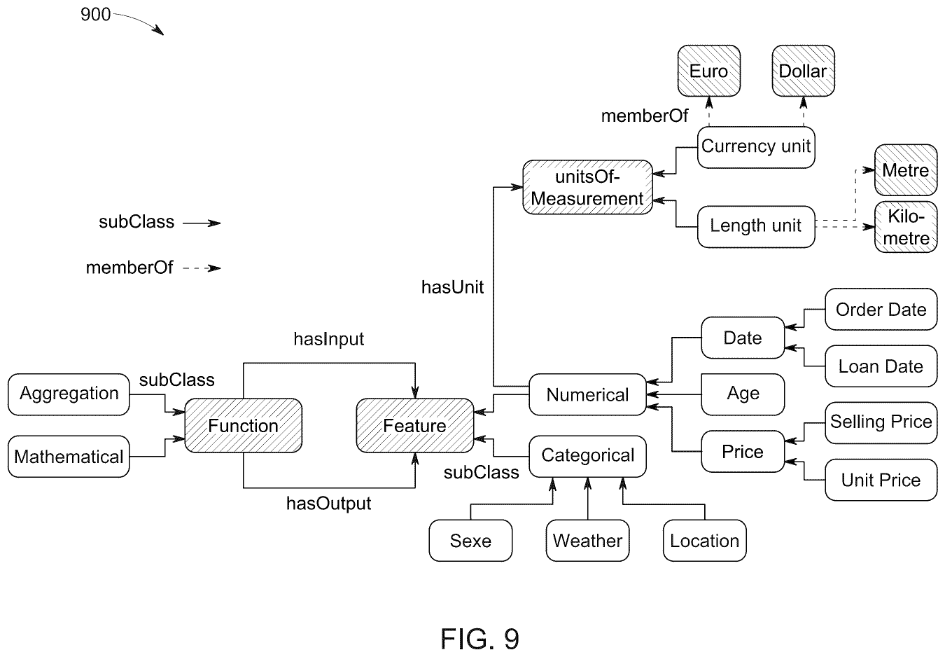

Component 560 receives the new features and annotates the features based on logical entities specified in facts 567 of domain ontology 565. Domain ontology 565 may be considered a knowledge base defining a hierarchy of n logical entities, as well as assertions, or rules, 569. FIG. 9 illustrates portion 900 of a domain ontology according to some embodiments. Portion 900 represents relationships between super-classes as well as subclasses and members thereof.

The annotated features are received by reasoning engine 570, which uses assertions or rules 569 to determine whether or not each of the annotated features is “interpretable”. Rules 569 may comprise DL which defines, based on annotations referring to facts 567, scenarios in which a feature is considered interpretable and scenarios in which a feature is considered uninterpretable. In one example, the features (a, b, c, a+b, a+c, b+c) are received by reasoning engine 570 and rules 569 indicate that features having different units of measurement cannot be summed. If a and c have different units of measurement, then feature a+c is identified as non-interpretable.

Reasoning engine 570 passes features identified as interpretable (or all features which have not been identified as non-interpretable) to feature performance determination component 575. Feature performance determination component 575 determines the performance of the received set of features. The performance may be determined by training a machine learning model based on the set of features and evaluating the trained model (e.g., using test data) to determine one or more performance metrics of the trained model. The machine learning model is selected for its ability to perform of a particular desired inference, including but not limited to as a regression (e.g., predicted profit based on features derived from a Sales database table) or a classification (e.g., predicted most-popular product configuration based on features derived from a Customer database table).

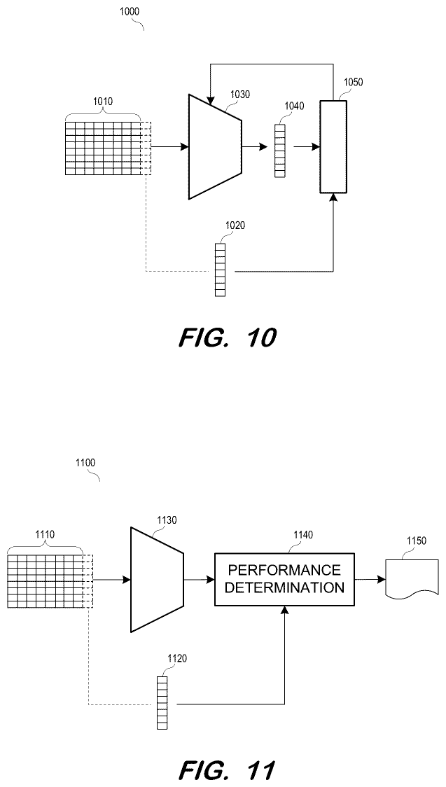

FIG. 10 illustrates training architecture 1000 which may be used by feature performance determination component 575 in some embodiments. Model 1030 may comprise a regression model implemented using a neural network, a set of linear equations or in any other suitable manner to determine a Profit value based on a set of input features. Columns 1010 include training data, where each of columns 1010 includes values corresponding to one of the features received by feature performance determination component 575. For example, if the new state consists of features (a, b, c, a², b², c²), columns 1010 include a column of data values for each of features a, b, c as well as a column of data values for each of features a², b², c², where the data values of the latter columns are equal to the square of the data values of the corresponding former columns. Column 1020 includes a ground truth value of the Profit target for each row of columns 1010.

One training iteration according to some embodiments may include inputting columns 1010 to model 1030, operating model 1030 to output resulting inferred values 1040 for each record of columns 1010, operating loss layer 1050 to evaluate a loss function based on output inferred values 1040 and known ground truth data 1020, and modifying model 1030 based on the evaluation. Iterations may continue until a threshold number of iterations have been performed, for example.

The performance of the trained network is then evaluated as a proxy for the statistical performance of the features. Performance may be determined by calculating any one or more performance metrics based on the output of the trained network in response to input data and known ground truths associated with the input data. FIG. 11 illustrates system 1100 to determine performance of a trained network according to some embodiments. Columns 1110 include test data associated with the same features represented by columns 1010 of training data. Column 1120 includes ground truth data values (i.e., of a Profit target) associated with each row of columns 1110.

Trained model 1130 receives columns 1110 and outputs an inferred value for each row of columns 1110 to performance determination component 1140. Performance determination component 1140 compares the received values to corresponding values of column 1120 to determine one or more performance metrics (e.g., accuracy, precision, recall) 1150.

Reward computation component 580 determines a reward based on the interpretable features output by reasoning engine 570 and on the performance determined by component 575. In one simple example, the reward is based on the ratio of interpretable features to uninterpretable features generated by feature generation component, and on whether or not the performance has improved since a last determination of performance based on a last-determined set of interpretable features.

The interpretable features (and, in some embodiments, features which were not identified as interpretable or uninterpretable) are input to feature vector generation component 530. Feature vector generation component 530 may determine a feature vector representing each of these features as described above, generate a composite vector therefrom, and input the composite vector to agent 510 in order to generate additional features. According to some embodiments, the new feature vector may represent features other than the last-determined features.

Feature vector generation component 530 may require additional logic to determine a feature vector representing a feature which itself is a combination of other features. For example, if a new feature (e.g., Z) is generated using the Sum or Product of two other features (e.g., X and Y), feature vector generation component 530 may determine whether feature Z is equivalent to a concept in taxonomy 550. If so, feature vector generation component 530 determines a feature vector for feature Z in a same manner as in the case of features represented in taxonomy 550. In a case that Z=Distance (X)÷Time (Y), component 530 determines that taxonomy 550 includes the concept Speed which is equal to distance divided by time and therefore identifies the feature Z as equivalent to the concept Speed. In another example, Z=unitPrice (X)*QuantitySold (Y), which is identified in taxonomy 550 as the Total Sale Price concept.

If no concept is determined as equivalent to the new feature Z, its units of measurement are used to identify any correspondence with a concept of taxonomy 550. For example, given Z=m*c² and a corresponding unit of measurement kg*m²/s², it is determined that no concept of taxonomy 550 is equivalent thereto. However, taxonomy 550 includes the concept of Kinetic Energy which is correlated to the product of the mass of an object and the square of its velocity (i.e. kinetic energy=½ m*v²). Since the unit of Kinetic Energy is kg*m²/s², feature vector generation component 530 determines that feature Z is related to the concept Energy and generates a feature vector based on the logical relationships of the concept Energy.

If the new feature is not determined to be equivalent or correspond to a known concept, feature vector generation component 530 may generate a feature vector including 1 in the entries corresponding to ‘dimensions’ and ‘numerical’ and 0 in the other entries. However, since such a feature should be considered noninterpretable by reasoning engine 570, feature vector generation component 530 might not encounter such a feature in some embodiments.

At any time, it may be determined to terminate training of agent 510 based on some criteria, including but not limited to a threshold number of reward computation cycles, an amount of time elapsed, an amount of processing power used, and the meeting of interpretability and performance thresholds.

Thusly-trained deep reinforcement learning network agent 510 may be subsequently used to determine features based on an input set of raw features. For example, a composite feature vector is determined based on the raw features and input to the trained network. The trained network outputs an operator which is used to generate new features based on the input features and a new composite feature vector is determined based on all the features. Iterations may continue to generate more and more features to increase the accuracy of the model which will be trained based on these features. However, at some point it is desirable to cease the iterations due to the increase in processing time required to train and operate a model as the number of features increase. The final set of determined features may then be output to a user as a recommendation and/or used to train a suitable model.

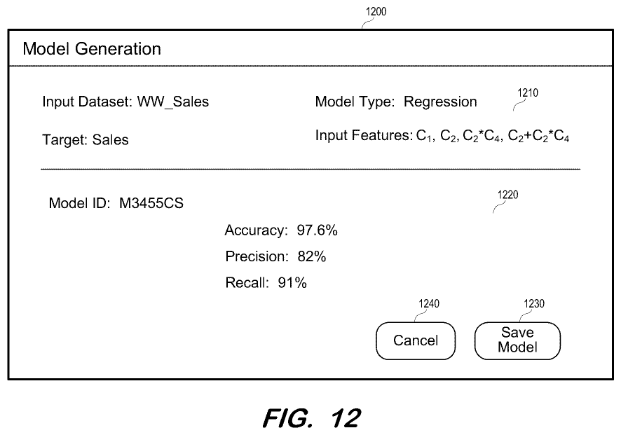

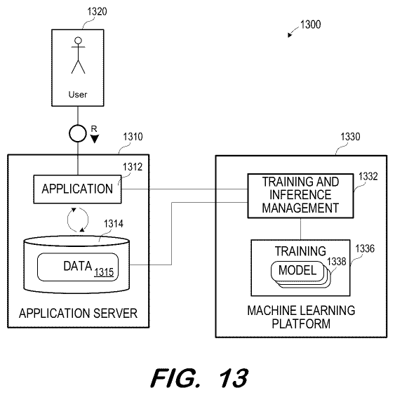

FIG. 12 illustrates interface 1200 presenting information associated with a model trained using features generated according to some embodiments. User interface 1200 may be presented by a user device executing a client application (e.g., a Web application) which provides definition and training of machine learning models.

User interface 1200 includes area 1210 presenting various configuration parameters of a trained model. The configuration parameters include an input dataset (e.g., an OLAP cube), a type of model (i.e., Regression), and a training target (i.e., Sales). Area 1210 also specifies interpretable input features which were generated based on raw features of the input dataset as described above.

Area 1220 provides information regarding a model which has been trained based on the configuration parameters of area 1210. In the illustrated example, area 1220 specifies an identifier of the trained model and determined accuracy, precision and recall values. Embodiments are not limited to the information of area 1220. A user may review the information provided in area 1220 to determine whether to save the trained model for use in generating future inferences (e.g., via Save Model control 1230) or to discard the trained model (e.g., via Cancel control 1240).

FIG. 13 illustrates system 1300 to provide model training to applications according to some embodiments. Application server 1310 may comprise an on-premise or cloud-based server providing an execution platform and services to applications such as application 1312. Application 1312 may comprise program code executable by a processing unit to provide functions to users such as user 1320 based on logic and on data 1315 stored in data store 1314. Data 1315 may be column-based, row-based, object data or any other type of data that is or becomes known. Data store 1314 may comprise any suitable storage system such as a database system, which may be partially or fully remote from application server 1310, and may be distributed as is known in the art.

According to some embodiments, user 1320 may interact with application 1312 (e.g., via a Web browser executing a client application associated with application 1312) to request a trained model based on data of data 1315. The data may comprise data aggregated across dimensions of an OLAP cube. In response to the request, application 1312 may call training and inference management component 1332 of machine learning platform 1330 to request training of a corresponding model according to some embodiments.

Based on the request, training, and inference management component 1332 may receive the specified data from data 1315 and instruct training component 1336 to train a model 1338 based on dimension-reduced training data as described herein. Application 1312 may then use the trained model to generate inferences based on input data selected by user 1320.

In some embodiments, application 1312 and training and inference management component 1332 may comprise a single system, and/or application server 1310 and machine learning platform 1330 may comprise a single system. In some embodiments, machine learning platform 1330 supports model training and inference for applications other than application 1312 and/or application servers other than application server 1310.

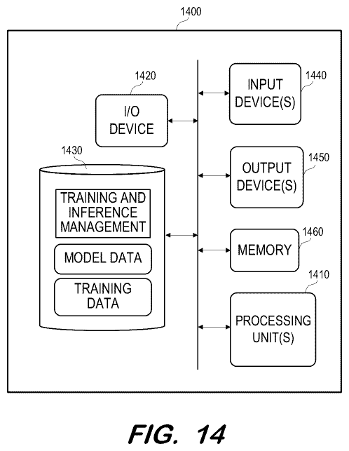

FIG. 14 is a block diagram of a hardware system providing model training according to some embodiments. Hardware system 1400 may comprise a general-purpose computing apparatus and may execute program code to perform any of the functions described herein. Hardware system 1400 may be implemented by a distributed cloud-based server and may comprise an implementation of machine learning platform 1330 in some embodiments. Hardware system 1400 may include other unshown elements according to some embodiments.

Hardware system 1400 includes processing unit(s) 1410 operatively coupled to I/O device 1420, data storage device 1430, one or more input devices 1440, one or more output devices 1450 and memory 1460. I/O device 1420 may facilitate communication with external devices, such as an external network, the cloud, or a data storage device. Input device(s) 1440 may comprise, for example, a keyboard, a keypad, a mouse or other pointing device, a microphone, knob or a switch, an infra-red (IR) port, a docking station, and/or a touch screen. Input device(s) 1440 may be used, for example, to enter information into hardware system 1400. Output device(s) 1450 may comprise, for example, a display (e.g., a display screen) a speaker, and/or a printer.

Data storage device 1430 may comprise any appropriate persistent storage device, including combinations of magnetic storage devices (e.g., magnetic tape, hard disk drives and flash memory), optical storage devices, Read Only Memory (ROM) devices, and RAM devices, while memory 1460 may comprise a RAM device.

Data storage device 1430 stores program code executed by processing unit(s) 1410 to cause system 1400 to implement any of the components and execute any one or more of the processes described herein. Embodiments are not limited to execution of these processes by a single computing device. Data storage device 1430 may also store data and other program code for providing additional functionality and/or which are necessary for operation of hardware system 1400, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing processor-executable program code; and
at least one processing unit to execute the processor-executable program code to cause the system to:
generate a first plurality of features using a learning network;
determine an interpretability of each of the first plurality of features based on a domain ontology and on symbolic rules associated with entities of the domain ontology;
determine a first set of the first plurality of features which were determined as interpretable;
determine a performance of a model trained using the first set of the plurality of features;
determine a reward based on the performance and the interpretability; and
generate a second plurality of features using the learning network based on the reward.

2. A system according to claim 1, wherein determination of an interpretability of each of the first plurality of features comprises:
annotation of each of the first plurality of features based on the entities of the domain ontology.

3. A system according to claim 2, wherein determination of an interpretability of each of the first plurality of features comprises:
executing symbolic reasoning by applying the symbolic rules to the annotated first plurality of features.

4. A system according to claim 3, wherein the symbolic reasoning comprises subsumption and instance checking.

5. A system according to claim 1, wherein the model is trained using the first set of the plurality of features and a second set of the plurality of features which were not determined as non-interpretable.

6. A system according to claim 1, wherein determination of an interpretability of each of the first plurality of features comprises:
executing symbolic reasoning by applying the symbolic rules to the first plurality of features.

7. A system according to claim 6, wherein the symbolic reasoning comprises subsumption and instance checking.

8. A method comprising:
generating a first plurality of features using a learning network;
determining an interpretability of each of the first plurality of features based on a domain ontology and on symbolic rules associated with entities of the domain ontology;
determining a first set of the first plurality of features which were determined as interpretable;
determining a performance of a model trained using the first set of the plurality of features;
determining a reward based on the performance and the interpretability; and
generating a second plurality of features using the learning network based on the reward.

9. A method according to claim 8, wherein determining an interpretability of each of the first plurality of features comprises:
annotating each of the first plurality of features based on the entities of the domain ontology.

10. A method according to claim 9, wherein determining an interpretability of each of the first plurality of features comprises:
executing symbolic reasoning by applying the symbolic rules to the annotated first plurality of features.

11. A method according to claim 10, wherein the symbolic reasoning comprises subsumption and instance checking.

12. A method according to claim 8, wherein the model is trained using the first set of the plurality of features and a second set of the plurality of features which were not determined as non-interpretable.

13. A method according to claim 8, wherein determining an interpretability of each of the first plurality of features comprises:
executing symbolic reasoning by applying the symbolic rules to the first plurality of features.

14. A method according to claim 13, wherein the symbolic reasoning comprises subsumption and instance checking.

15. A non-transitory medium storing executable program code executable by at least one processing unit of a computing system to cause the computing system to:
generate a first plurality of features using a learning network;
determine an interpretability of each of the first plurality of features based on a domain ontology and on symbolic rules associated with entities of the domain ontology;
determine a first set of the first plurality of features which were determined as interpretable;
determine a performance of a model trained using the first set of the plurality of features;
determine a reward based on the performance and the interpretability; and
generate a second plurality of features using the learning network based on the reward.

16. A medium according to claim 15, wherein determination of an interpretability of each of the first plurality of features comprises:
annotation of each of the first plurality of features based on the entities of the domain ontology.

17. A medium according to claim 16, wherein determination of an interpretability of each of the first plurality of features comprises:
execution of symbolic reasoning by applying the symbolic rules to the annotated first plurality of features.

18. A medium according to claim 17, wherein the symbolic reasoning comprises subsumption and instance checking.

19. A medium according to claim 15, wherein the model is trained using the first set of the plurality of features and a second set of the plurality of features which were not determined as non-interpretable.

20. A medium according to claim 15, wherein determination of an interpretability of each of the first plurality of features comprises:
execution of subsumption and instance checking on the first plurality of features using the symbolic rules.
